(19) United States
(12) Patent Application Publication
(10) Pub. No.: US 2013/0197919 A1
(43) Pub. Date: Aug. 1, 2013

(54) "METHOD AND DEVICE FOR DETERMINING A NUMBER OF BITS FOR ENCODING AN AUDIO SIGNAL"

(71) Applicants: Te Li, Singapore (SG); Rongshan Yu, Singapore (SG); Haiyan Shu, Singapore (SG); Susanto Rahardja, Singapore (SG)

(72) Inventors: Te Li, Singapore (SG); Rongshan Yu, Singapore (SG); Haiyan Shu, Singapore (SG); Susanto Rahardja, Singapore (SG)

(73) Assignee: AGENCY FOR SCIENCE, TECHNOLOGY AND RESEARCH, Singapore (SG)

(21) Appl. No.: 13/574,535

(22) PCT Filed: Jan. 22, 2010
(86) PCT No.: PCT/SG10/00017

§ 371 Date: Oct. 15, 2012

(51) Int. Cl. G10L 19/002

(52) U.S. Cl. CPC G10L 19/002
USPC 704/500

(57) ABSTRACT

A method for determining a number of bits for encoding an audio signal comprising a core audio signal portion and a residual audio signal portion is described that comprises selecting, from the residual audio signal portion, a reference residual audio signal portion and at least one candidate residual audio signal portion; comparing the reference residual audio signal portion with the candidate residual audio signal portion; and determining the number of bits for encoding the audio signal depending on the result of the comparison.

Embodiments of the invention generally relate to a method and a device for determining a number of bits for encoding an audio signal.

Online music stores have shown the viability of online music sales. An existing limitation of online music sales is that the music files are only offered at fixed bit rates in lossy compressed form. However, with the proliferation of broadband access and continuous decline of memory storage prices, there is an increasing number of music lovers who wish to purchase their favorite music online at a high resolution which is as good as CD quality. On the other hand, some users may prefer to purchase songs that are cheaper but are encoded at a lower bit rate. This is because the perceptual audibility between, for example, an audio file encoded at 96 kbps and an audio file encoded at 128 kpbs is transparent or not important to such users, for example in case that the music is played on a mobile device.

In order to satisfy the various bit rate and quality requirements of their customers, music stores may archive different versions of the same piece of music at different bit rates on their file servers. This is a burden for the file servers since it increases the complexity of the data management and the amount of necessary storage space.

Alternatively, a music store may prefer to encode songs at a required bit rate only when a purchase order is received for the required bit rate. This, however, is both time consuming and computationally intensive. Moreover, there may be customers who may wish to upgrade a piece of music, e.g. a song that they have purchased to a better quality, for example in case that they want to listen to the song using a hi-fi system. In this case, the only option would be to purchase and download the entire song with a larger size, resulting in them having to keep different versions of the same song. It is therefore not pragmatic to employ fixed bit rate audio coding on an online music store offering multiple qualities for songs for both the online music store and its customers.

Fine granular scalable audio coding, which has been extensively studied recently, provides a solution to variable quality requirements of audio files. Released by the ISO in late 2006, MPEG-4 audio scalable lossless coding (SLS, cf. e.g. [1] and [2]) integrates the functions of lossless audio coding, perceptual audio coding and fine granular scalable audio coding in a single framework. It allows the scaling up of a perceptually coded representation such as a MPEG-4 AAC coded piece of audio to a lossless representation of the piece of audio with fine granular scalability, i.e. with a wide range of intermediate bit rate representations.

Furthermore, a music manager system based on SLS coding technology has been designed for online music stores. With such a music manager system, a server maintained by an online store is able to deliver songs to its clients at various bit rates and prices with single file archival for each piece of music. The processing of the files may be performed very fast and the upgrading of the quality of a piece of music by a customer can be easily and efficiently achieved by offering a “top-up” to the original song without the need of keeping multiple copies for the same piece of music.

In this way, multi-bit rate music files are currently provided by online music stores. However, this does not mean that multi-quality music sales are already available. This is because the quality of music at a fixed bit rate may vary for different pieces of music.

The multi-quality model is more desirable, but there is a lack of a clear link between scalable audio bit rate and perceptual quality.

Embodiments may be seen to be based on the problem to optimize the perceptual quality of an encoded audio signal under a pre-determined constraint on the amount of coding bits for the encoded audio signal.

This problem is solved by the methods and devices according to the independent claims.

In one embodiment, a method for determining a number of bits for encoding an audio signal is provided including a core audio signal portion and a residual audio signal portion, wherein the method includes selecting, from the residual audio signal portion, a reference residual audio signal portion and at least one candidate residual audio signal portion; comparing the reference residual audio signal portion with the candidate residual audio signal portion; and determining the number of bits for encoding the audio signal depending on the result of the comparison.

According to another embodiment, a device for determining a number of bits for encoding an audio signal according to the method described above is provided.

Illustrative embodiments of the invention are explained below with reference to the drawings.

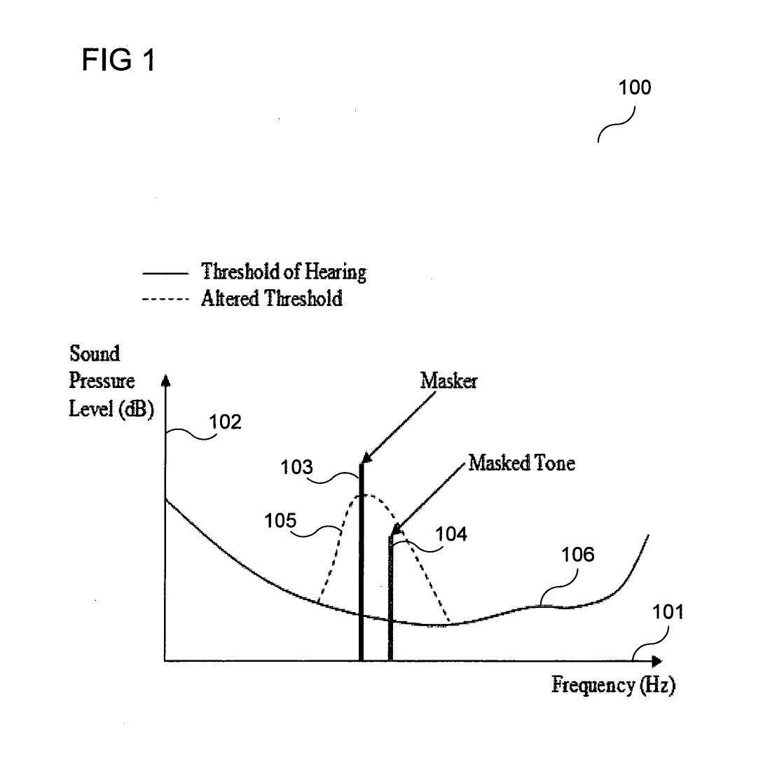

FIG. 1 shows a frequency-sound pressure level diagram.

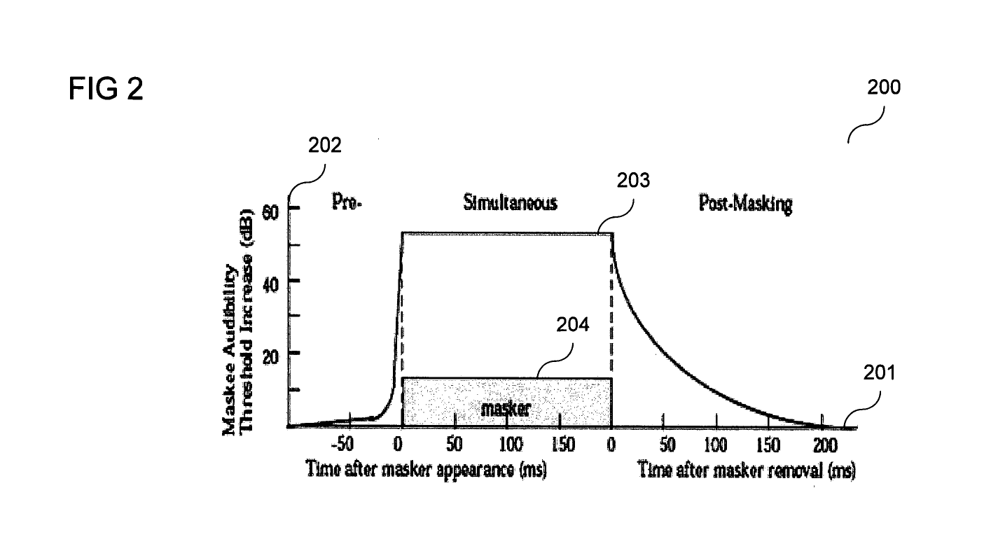

FIG. 2 shows a time-threshold increase diagram.

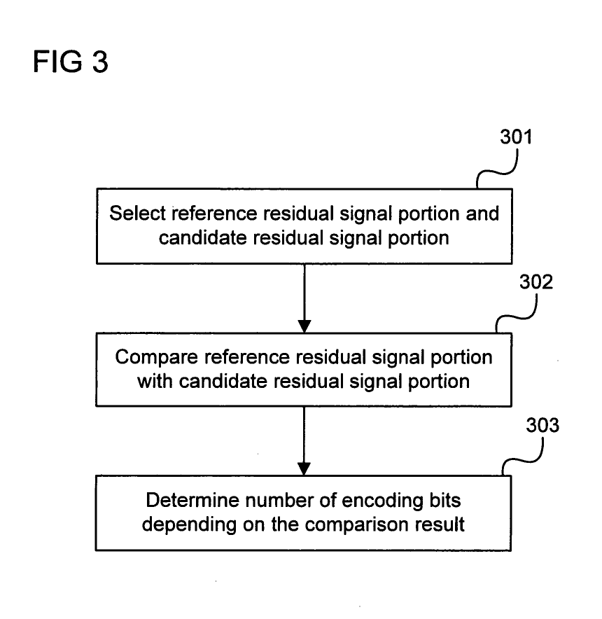

FIG. 3 shows a flow diagram according to an embodiment.

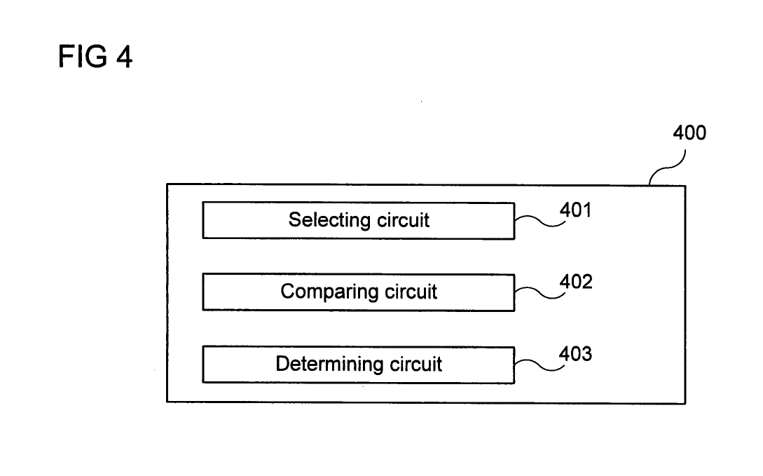

FIG. 4 shows a device according to an embodiment.

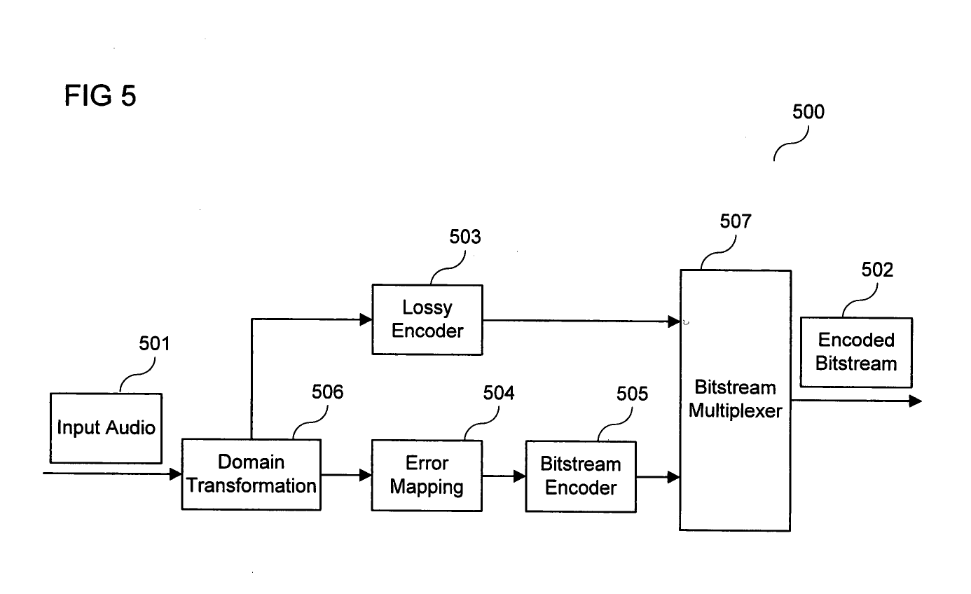

FIG. 5 shows an encoder according to an embodiment.

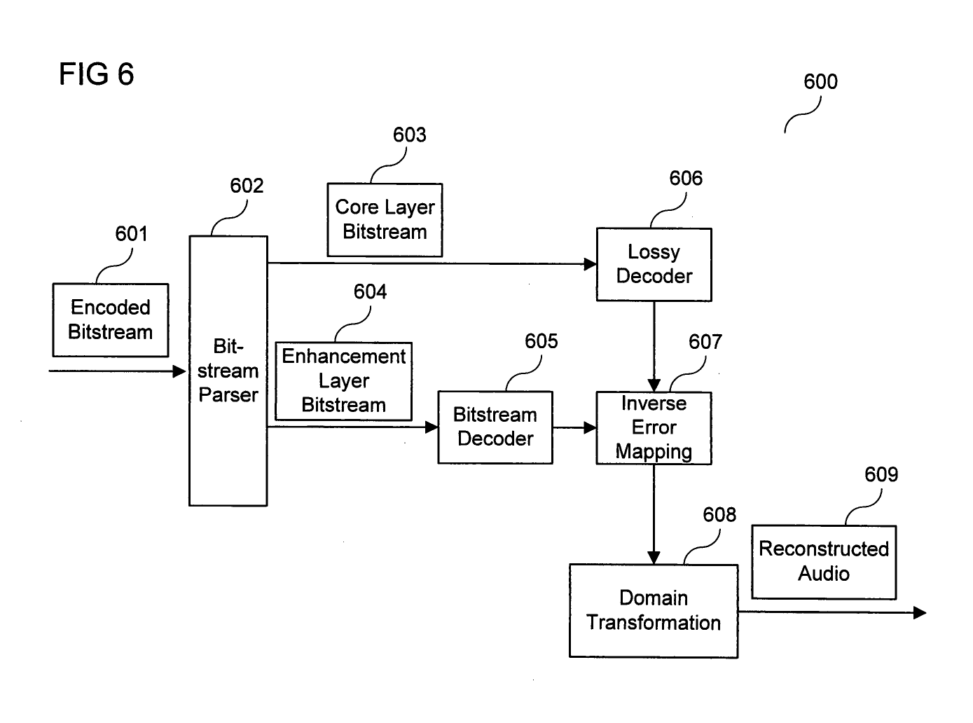

FIG. 6 shows a decoder according to an embodiment.

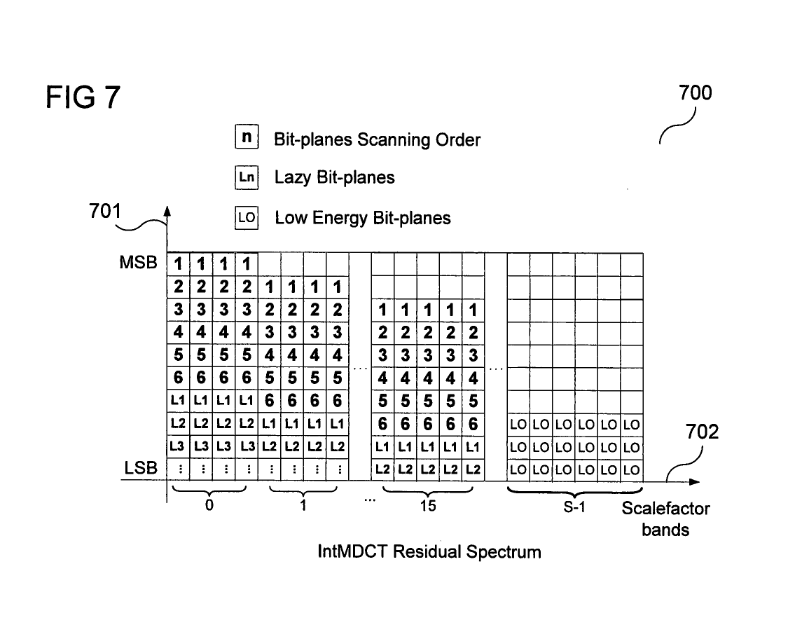

FIG. 7 shows a bit plane diagram.

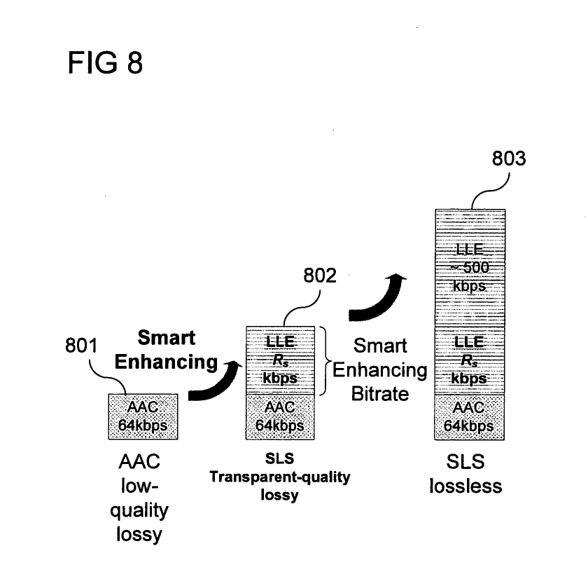

FIG. 8 shows a hierarchy of audio files.

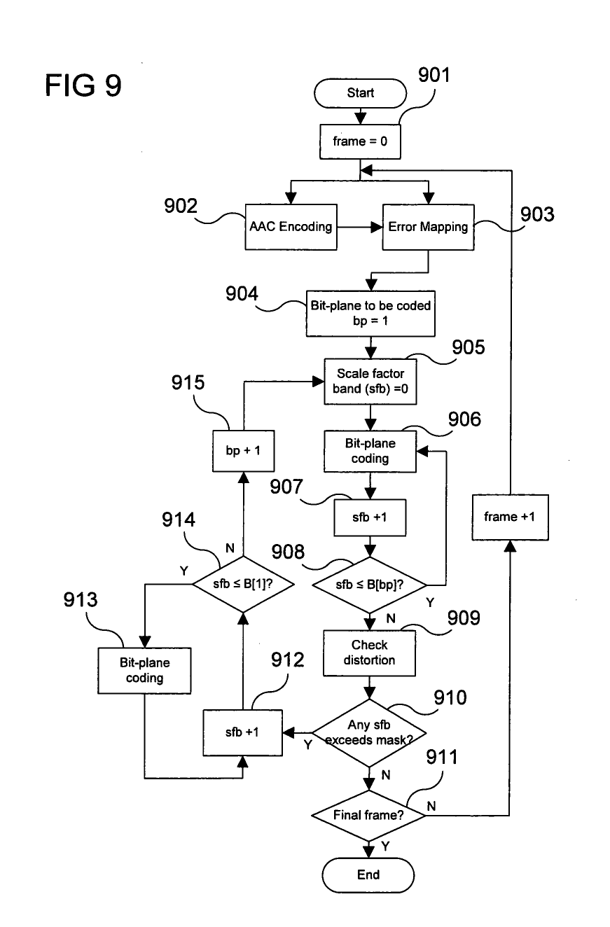

FIG. 9 shows a flow diagram.

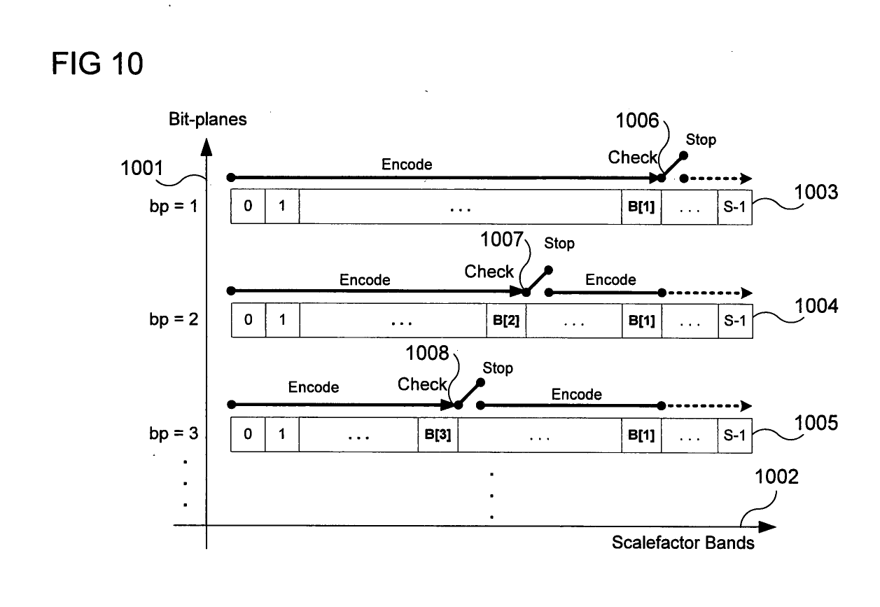

FIG. 10 shows a bit plane diagram.

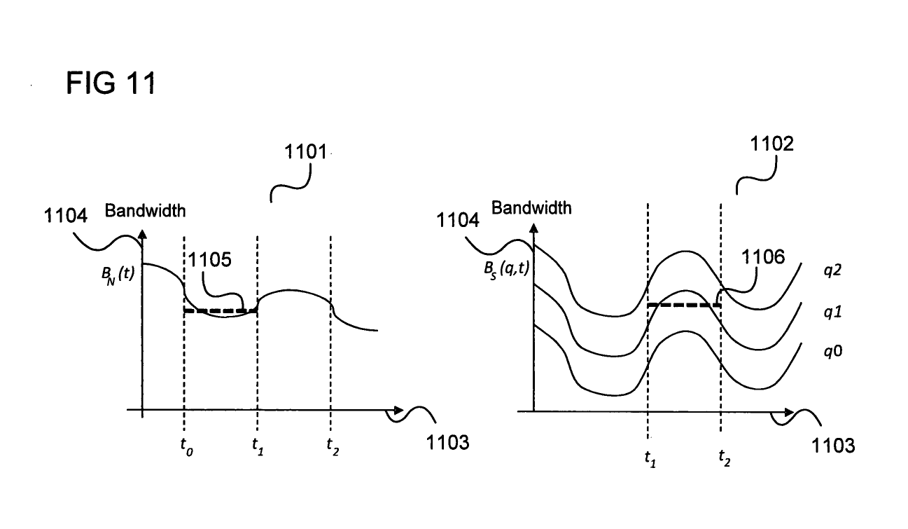

FIGS. 11A and 11B show bandwidth-time diagrams.

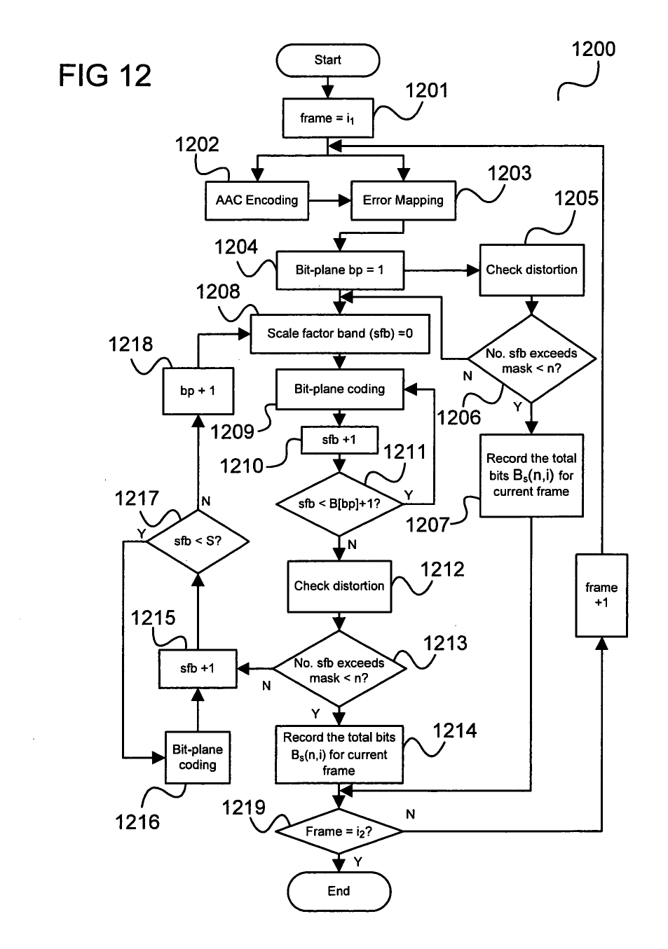

FIG. 12 shows a flow diagram according to an embodiment.

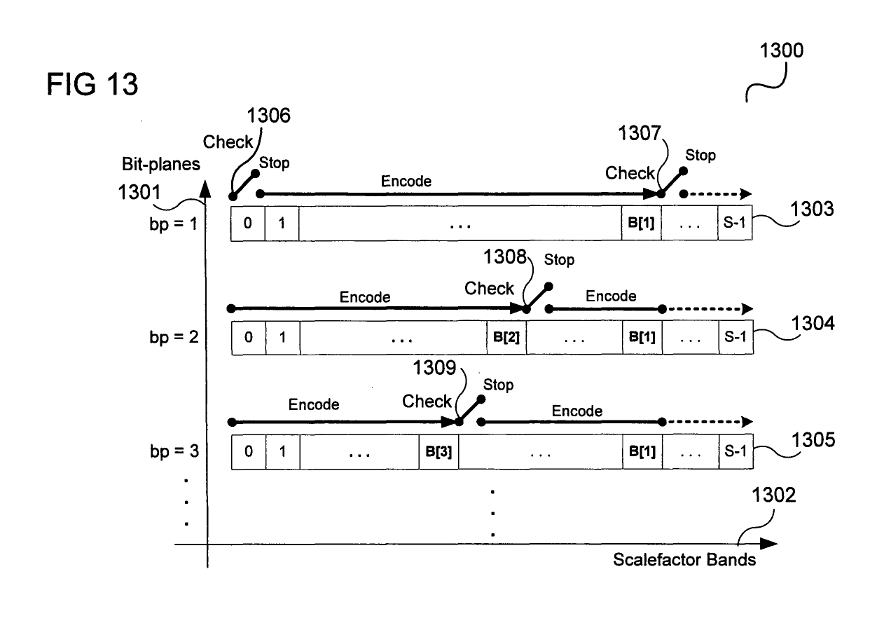

FIG. 13 shows a bit plane diagram according to an embodiment.

In some situations, an otherwise clearly audible sound can be masked by another sound. For example, conversation at a bus stop can be completely impossible if an incoming bus producing loud noise is driving past. This phenomenon is called Masking. A weaker sound is masked if it is made inaudible in the presence of a louder sound.

If two sounds occur simultaneously and one is masked by the other, this is referred to as simultaneous masking.

Simultaneous masking is also sometimes called frequency masking. This is illustrated in FIG. 1.

FIG. 1 shows a frequency-sound pressure level diagram 100.

Frequency values correspond to the values along a first axis (x-axis) 101 and sound pressure levels (in dB) correspond to values along a second axis (y-axis) 102.

A first line 103 illustrates a high intensity signal. The high intensity signal behaves like a masker and is able to mask a relatively weak signal (illustrated by a second line 104) in a nearby frequency range. The masking level is illustrated by a dashed line 105 while the audible level without masking is illustrated by a solid line 106.

Similarly to frequency masking, a weak sound emitted soon after the end of a louder sound may be masked by the louder sound. Even a weak sound just before a louder sound can be masked by the louder sound. These two effects are called pre- and post temporal masking, respectively. They are illustrated in FIG. 2.

FIG. 2 shows a time—threshold increase diagram 200.

Frequency values correspond to the values along a first axis (x-axis) 201 and the sound pressure level (in dB) correspond to values along a second axis (y-axis) 202.

A solid line 203 illustrates the audibility threshold increase that is caused by a masking signal illustrated by a block 204.

Masking may be applied in audio compression to determine which frequency components can be discarded or more compressed (e.g. by rougher quantization).

For example, perceptual audio coding is a method of encoding audio that uses psychoacoustic models to discard data corresponding to audio components which may not be perceived by humans.

Typically, frequencies from an audio signal are eliminated that the human ear cannot hear. Perceptual audio coding may also eliminate softer sounds that are being drowned out by louder sounds, i.e., advantage of masking may be taken. For example, an audio signal is first decomposed in several critical bands using filter banks. Average amplitudes are calculated for each frequency band and are used to obtain corresponding hearing thresholds.

In one embodiment, a method is provided that allows having an optimal (perceptual) quality of scalable audio for a time period for which the amount of bits of the encoded audio signal is limited by truncating the encoded bit stream for each audio frame according to a pre-trained bit rate table.

In one embodiment, this is applied in adaptive streaming, where the (perceptual) quality of the streaming audio is adaptive to the bandwidth available.

FIG. 3 shows a flow diagram 300 according to an embodiment.

The flow diagram 300 illustrates a method for determining a number of bits for encoding an audio signal including a core audio signal portion and a residual audio signal portion.

In 301, a reference residual audio signal portion and at least one candidate residual audio signal portion are selected from the residual audio signal portion.

In 302, the reference residual audio signal portion is compared with the candidate residual audio signal portion.

In 303, the number of bits for encoding the audio signal is determined depending on the result of the comparison.

In other words, in one embodiment, a candidate residual audio signal portion, e.g. a part of the residual audio signal portion such as a sub-set of the set of bits of the residual audio portion, is compared with a reference residual audio signal portion which may be a part of the residual audio signal portion that allows a higher quality than the candidate residual audio signal portion. Based on the comparison, the number of bits to be used for the encoding of the audio signal may be determined. For example, based on the comparison of one or more candidate audio signal portions, for each of one or more pre-defined (perceptual) quality levels, a number of bits may be determined that is required achieve the pre-defined quality level. A number of bits that is required for an encoded frame of an audio signal to have a pre-defined quality level may be determined for a plurality of frames and a plurality of quality levels. In this way, a table of bit numbers for a plurality of frames and a plurality of quality levels may be generated used in the further processing, e.g. in the encoding, to decide about the amount of bits used for the encoded audio signal. The bit numbers determined for a plurality of frames and a plurality of quality levels may be combined to determine the bit amount used for encoding the plurality of frames, for example the frames within a certain time period or interval of the audio signal. The number of bits or the bit amount may for example be used to determine at what length a bit-stream (that for example losslessly encodes the audio signal) may be truncated while still having a certain quality level and/or to satisfy an upper limit on the total amount of bits of the encoded plurality of frames. A quality level may for example specify a number of frequencies or scale factor bands for which a threshold, e.g. a masking threshold, is allowed to be exceeded by noise or distortion resulting from the lossy encoding of the audio signal. For example, for each frame one of the quality levels is selected based on the number of bits required for that quality level and the frame is encoded according to this quality level, e.g. the residual audio signal portion corresponding to the selected quality level is used for the encoded frame.

In one embodiment, the method further includes encoding the audio signal using the determined number of bits.

The audio signal may be a frame of an (overall) audio signal including a plurality of frames. For example, the amount of encoding bits for the (overall) audio signal, e.g. a plurality of frames, is pre-determined (e.g. a specification of the amount is received) and a number of bits for encoding each frame of the plurality of frames is to be determined according to the above method such that the total number of bits for encoding all frames of the plurality of frames, i.e. for the encoded plurality of frames, is at most the pre-determined amount of encoding bits. Thus, the method may serve to determine the amount of coding bits of one frame (or generally a part of an audio signal) for a plurality of frames such that the bits required for the encoded plurality of frames is below a maximum bit amount while the perceptual quality of each frame or the plurality of frames is optimized.

The method may further include determining, based on the result of the comparison, whether or not the at least one candidate residual audio signal portion fulfills a pre-determined quality criterion. For example, the pre-determined quality criterion is selected from a plurality of quality criteria and the frame should for example be encoded such that the quality of the encoded frame is optimized, i.e. that the best quality criterion, i.e. the quality criterion that yields, if fulfilled, the highest perceptual quality among the plurality of quality criteria, is fulfilled by the encoded frame.

In one embodiment, the number of bits is determined as the number of bits of the candidate residual audio signal portion if the candidate residual audio signal portion fulfills the pre-determined quality criterion.

The method may further include selecting at least one other candidate residual audio signal portion from the residual audio signal portion; determining, from among the candidate residual audio signal and the at least one other candidate residual audio signal portion, a first residual audio signal portion for which the pre-determined quality criterion is fulfilled by at least a comparison of the candidate residual audio signal portion with the reference residual candidate audio signal portion; determining, from among the candidate residual audio signal and the at least one other candidate residual audio signal portion, a second residual audio signal portion for which a pre-determined other quality criterion is fulfilled by at least a comparison of the candidate residual audio signal portion with the reference residual candidate audio signal portion; and determining the number of bits for encoding the frame based on the first candidate residual audio signal portion and the second candidate residual audio signal portion. For example, the number of bits for encoding the frame is determined based on a combination of the number of bits required for the first candidate residual audio signal portion and the number of bits required for the second candidate residual audio signal portion.

In one embodiment, the core audio signal portion includes a plurality of core audio signal values and the residual audio signal portion includes a plurality of residual audio signal values.

The reference residual audio signal portion is for example the residual audio signal portion.

In one embodiment, the reference candidate residual audio signal portion is different from the candidate residual audio signal portion.

In one embodiment, comparing the reference candidate residual audio signal portion with the candidate residual audio signal portion includes checking whether the difference between at least one first residual value reconstructed from the reference candidate residual audio signal portion according to a pre-determined reconstruction scheme and at least one second residual value reconstructed from the candidate residual audio signal portion according to the pre-determined reconstruction scheme is lower than a pre-defined threshold.

The pre-defined threshold may for example be based on a human hearing perception threshold. The pre-defined threshold is for example based on a human hearing mask.

In one embodiment, the residual audio signal portion includes a plurality of residual audio signal values and the number of bits for encoding the audio signal is determined depending on the number of residual values, for which the difference between a first corresponding residual value reconstructed from the reference candidate residual audio signal portion according to a pre-determined reconstruction scheme and a second corresponding residual value reconstructed from the candidate residual audio signal portion according to the pre-determined reconstruction scheme is lower than the pre-defined threshold.

In one embodiment, the residual audio signal portion includes a plurality of residual audio signal values, and selecting the second candidate residual audio signal portion is performed based on a bit word representation of each residual audio signal value and based on an order of the residual audio signal values.

For example, selecting the candidate residual audio signal portion includes determining a minimum bit significance level; determining a border signal value position; including all bits of the bit word representations of the residual audio signal values that have, in their respective bit word, a higher bit significance level than the minimum bit significance level; and including all bits of the bit word representations of the residual audio signal values that have, in their respective bit word, the minimum bit significance level and that are part of a bit word representation of a signal value that has a position which fulfills a pre-defined condition with regard to the border signal value position.

The pre-defined condition may for example be one of the position being below the border signal value position; the position being below or equal to the border signal value position; the position being above the border signal value position; and the position being above or equal to the border signal value position.

In one embodiment, the minimum bit significance level is determined based on a comparison of the reference candidate residual audio signal portion with a further candidate residual audio signal portion or is a pre-defined minimum bit significance level.

The border signal value position may be determined based on a comparison of the first candidate residual audio signal portion with a further candidate residual audio signal portion or is a pre-defined border signal value position.

In one embodiment, each residual audio signal value corresponds to at least one frequency. For example, each residual audio signal value corresponds to at least one scale factor band.

The method for encoding an audio signal illustrated in FIG. 3 is for example carried out by an encoder as illustrated in FIG. 4.

FIG. 4 shows a device 400 according to an embodiment.

The device 400 serves for determining a number of bits for encoding an audio signal including a core audio signal portion and a residual audio signal portion.

The device 400 includes a selecting circuit configured to select, from the residual audio signal portion, a reference residual audio signal portion and at least one candidate residual audio signal portion.

The device 400 further includes a comparing circuit configured to compare the reference residual audio signal portion with the candidate residual audio signal portion.

Additionally, the device 400 includes a determining circuit configured to determine the number of bits for encoding the audio signal depending on the result of the comparison.

The device 400 may include a memory which is for example used in the processing carried out by the device.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

An example for a device 400, for example configured to perform the method illustrated in FIG. 3 is shown in FIG. 5.

FIG. 5 shows an encoder 500 according to an embodiment.

The encoder 500 receives an audio signal 501 as input, which is for example an original uncompressed audio signal which should be encoded to an encoded bit stream 502.

The audio signal 501 is for example in integer PCM (Pulse Code Modulation) format and is losslessly transformed into the frequency domain by a domain transforming circuit 506 which for example carries out an integer modified discrete Cosine transform (IntMDCT).

The resulting frequency coefficients (e.g. IntMDCT coefficients) are passed to a lossy encoding circuit 503 (e.g. an AAC encoder) which generates the core layer bit stream, e.g. an AAC bit stream, in other words a core audio signal portion. The lossy encoding circuit 503 for example groups the frequency coefficients grouped into scale factor bands (sfbs) and quantizes them for example with a non-uniform quantizer. In order to efficiently utilize the information of the spectral data that has been coded in the core layer bit stream, an error-mapping procedure is employed by an error mapping circuit 504 which receives the frequency coefficients and the core layer bit stream as input to generate an residual spectrum (e.g. a lossless enhancement layer, LLE), in other words a residual audio signal portion, by subtracting the quantized frequency coefficients generated by the lossy encoder (e.g. the AAC quantized spectral data) from the original frequency coefficients. The encoder 500 may thus be seen to include a core layer and a (lossless) enhancement layer.

As an example, for k={0, 1, . . . , N−1} where N is the dimension of IntMDCT, the residual signal e[k] is for example computed by

$$e [ k ] = \{ \begin{matrix}c [ k ] , & i [ k ] = 0 \\ c [ k ] - ⌊ thr ( i [ k ] ) ⌋ , & i [ k ] \neq 0\end{matrix}$$

where c[k] is the IntMDCT coefficient, i[k] is the quantized data vector produced by the quantizer (i.e. the lossy encoding circuit 503), └•┘ is the flooring operation that rounds off a floating-point value to its nearest integer with smaller amplitude and thr(i[k]) is the low boundary (towards-zero side) of the quantization interval corresponding to i[k].

The residual spectrum is then encoded by a bit stream encoding circuit 505, for example according to the bit plane Golomb code (BPGC), context-based arithmetic code (CBAC) and low energy mode coding (LEMC) to generate a scalable enhancement layer bit stream (e.g. a scalable LLE layer bit stream).

Finally, the scalable enhancement layer bit stream is multiplexed by a multiplexer 507 with the core layer bit stream to produce the encoded bit stream 502.

The encoded bit stream 502 may be transmitted to a receiver which may decode it using a decoder corresponding to the encoder 500. An example for a decoder is shown in FIG. 6.

FIG. 6 shows a decoder 600 according to an embodiment.

The decoder 600 receives an encoded bit stream 601 as input. A bit stream parsing circuit 602 extracts the core layer bit stream 603 and the enhancement layer bit stream 604 from the encoded bit stream. The enhancement layer bit stream 604 is decoded by a bit stream decoding circuit 605 corresponding to the bit stream encoding circuit 505 to reconstruct the residual spectrum as exact as it is possible from the transmitted encoded bit stream 601.

The core layer bit stream 603 is decoded by a lossy decoding circuit 606 (e.g. an AAC decoder) and is combined with the reconstructed residual spectrum by an inverse error mapping circuit to generate the reconstructed frequency coefficients.

The reconstructed frequency coefficients are transformed into the time domain by a domain transforming circuit 608 corresponding to the domain transforming circuit 506 (e.g. an integer inverse MDCT) to generate a reconstructed audio signal 609.

By selecting how much of the residual spectrum generated by the error mapping circuit 504 is transmitted to the decoder 600, the reconstructed audio signal 609 is scalable from lossy to lossless.

In SLS (MPEG-4 scalable lossless) coding, the bit stream encoding circuit 505 carries out a bit plane scanning scheme for encoding the residual spectrum. SLS, using this bit plane scanning scheme, allows the scaling up of a perceptually coded representation such as MPEG-4 AAC to a lossless representation with a wide range of intermediate bit rate representations.

The bit plane scanning scheme in SLS is illustrated in FIG. 7.

FIG. 7 shows a bit plane diagram 700.

In the bit plane diagram 700, the residual spectrum values are represented as bit words (i.e. words of bits), wherein each bit word is written as a column and the bits of each bit word are ordered according to their significance from most significant bit.

The significance of the bits in their respective bit word increases along a first axis 701 (y-axis). Each residual spectrum value for example corresponds to a frequency and belongs to a scale factor band. The scale factor band (sfb) number increases from left to right (from 0 to s−1) along a second axis 702 (x-axis).

The scanning process carried out by the bit stream encoding circuit 505 starts from the most significant bit of spectral data (i.e. of the residual spectrum values) for all scale factor bands. It then progresses to the following bit planes until it reaches the least significant bit (LSB) for all scale factor bands. Starting from the fifth bit plane or in this example the seventh bit plane (for CBAC), the bit plane scanning process enters the Lazy-mode coding for the lazy bit planes where the probability of a bit to be 0 or 1 is assumed to be equal.

As the frequency assignment rule of BPGC is derived from the Laplacian probability density function, BPGC only delivers excellent compression performance when the sources are near-Laplacian distributed. However, for some music items, there exist some “silence” time/frequency regions where the spectral data are in fact dominated by the rounding errors of IntMDCT. In order to improve the coding efficiency, low energy mode coding may be adopted for coding signals from low energy regions. A scale factor band is defined as low energy if L[s]≦0 where L[s] is the lazy bit plane as defined in [1] and [2].

It is possible to improve the coding efficiency of BPGC by further incorporating more sophisticated probability assignment rules that take into account the dependencies of the distribution of IntMDCT spectral data to several contexts such as their frequency locations or the amplitudes of adjacent spectral lines, which can be effectively captured by using CBAC. For CBAC coding, the seventh and below bit planes are set as absolute lazy bit planes in SLS reference codec.

The application of a method for smart enhancing is illustrated in FIG. 8.

FIG. 8 shows a hierarchy of audio files 801, 802, 803.

Smart enhancing provides the function that, with a low-quality audio input file (e.g. an AAC 64 kbps input) 801 and its original (uncompressed) format, it enables a scalable encoder to automatically encode the minimum amount of enhancing bits necessary to generate a transparent quality audio file 802 for this particular input. This transparent quality lossy format can also be further “topped-up” (upgraded) to a lossless format audio file 803.

For smart enhancing, the encoder 700 may for example carry out a process as it is explained in the following with reference to FIG. 9.

FIG. 9 shows a flow diagram 900 according to an embodiment.

The process is started in 901 with the first frame of the input audio signal 501. The input audio signal in the time domain is transferred into spectrum domain by the domain transforming circuit 506 (e.g. by an IntMDCT transform (with or without M/S (Main/Side) coding)) and encoded in 902 by the lossy encoding circuit 503, e.g. according to the MPEG-4 AAC encoding method. A perceptual hearing mask for this frame, given by a set of energy level values M[s], is generated in the coding process, with 0≦s<S where s is the scale factor band (sfb) number and S is the total number of scale factor bands.

In 903, as described above with reference to FIG. 5, the error mapping process carried out by the error mapping circuit 504 by calculating the difference between the lossy coded frequency components (e.g. the AAC coded spectrum) and the original spectrum provided by the domain transforming circuit 506.

In this embodiment, the residual signal values provided by the error mapping circuit are structured into residual bit planes by the bit stream encoding circuit 505. Let for each scale factor band s the maximum bit plane level (i.e. the position of the most significant bit in the bit words corresponding to the scale factor band s) be given by b_{M}[s]. The residual bit planes are processed according to a bit plane coding process, which may be carried out according to BPGC, CBAC or LEMC (Low Energy Mode Code).

The coding sequence that is used may be seen to correspond, in principle, to bit plane scanning according to SLS as illustrated in FIG. 7. For each scale factor band, the bit plane coding starts from b_{M}[s]. For example, for s=48, b_{M}[s]=5. For the whole frame, the bit plane to be coded (in other words, scanned) is indicated by bp. As shown in FIG. 7, the first bit plane (bp=1) includes the bit planes with scanning order “1”. The second by includes the bit planes with scanning order “2”, and so on.

In 904, the current (i.e. the currently processed) bit plane to be coded is set to bp=1.

For bp=1, the bit plane coding starts from sfb=0 in 1405 which is increased by 1 in 907 after bit plane coding the current (currently processed) scale factor band sfb of the current bit plane in 906. In 908, it is checked whether sfb≦B[bp].

If this is the case the process returns to 906 (with increased sfb) such that the scale factor runs (in the loop formed by 906 and 908) from sfb=0 to sfb=B[bp].

For example, B[1] is the last scale factor band in the first bit plane to be coded in 906, e.g. by BPGC/CBAC coding (non LEMC).

B[1] is for example defined as

L[s]0∀B[1]≦s≦S

where L[s] is the lazy bit plane as defined in [2].

If sfb≦B[bp] does not hold, the process continues with 909. In 909, a distortion check is performed. For example, for the first bit plane (bp=1), once the first bit plane for scale factor bands from 0 to B[1] is coded (which may also be seen as a collection of individual first bit planes for each scale factor band), the distortion check is performed.

The distortion check includes a direct bit plane reconstruction, filling element and comparison process.

The reconstructed value ē[k] [T] for residual frequency element k (0≦k<N, where N is the number of frequency coefficients per frame) in scale factor band s may be computed by using encoded bit planes from bp=1 to bp=T (current bit plane until which the bit plane coding has been carried out at the current stage):

$$\overline{e} [ k ] [ T ] = ( 2 \hat{ɛ} [ k ] - 1 ) {\sum }_{bp = 1}^{T} ( b [ k ] [ bp ] \cdot {2}^{( {b}^{M} [ s ] - bp )} )$$

where \hat{ε}[k] is the reconstructed sign symbol (0 or 1), b[k][bp] is the bit symbol (0 or 1) and b^{M}[s] is the total levels of bit planes for the current sfb.

If ē[k][T]≠0, the reconstruction can be further enhanced by an estimation process. Although the bit planes below the current bit plane bp=T have not been coded (yet), they can be estimated based on the Laplacian distribution feature of the frequency elements in SLS coding. This reconstruction enhancement is supposed to be performed in the SLS decoder (i.e., for example, the decoder 600), too. Specifically, the add-on amplitude for the following bit planes (i.e. the bit planes below bit plane T) can be estimated as

$$\tilde{e} [ k ] [ T ] = ( 2 \hat{ɛ} [ k ] - 1 ) {\sum }_{bp = T + 1}^{{b}^{M} [ s ]} ( {Q}_{bp}^{L [ s ]} \cdot {2}^{( {b}^{M} [ s ] - bp )} ) .$$

Here, Q_{bP}^{L[s]} is the frequency assignment for BPGC coding and is defined as

$${Q}^{L [ s ]} [ bp ] = \{ \begin{matrix}\frac{1}{1 + {2}^{2 L [ s ] - bp}} , & bp \leq L [ s ] \\ \frac{1}{2} , & bp > L [ s ]\end{matrix}$$

and the final reconstructed spectrum coefficient ê[k] [T] is obtained as

$$\hat{e} [ k ] [ T ] = \{ \begin{matrix}\overline{e} [ k ] [ T ] + e [ k ] [ T ] , & ∀ T < L [ s ] \\ \overline{e} [ k ] [ T ] , & otherwise\end{matrix}$$

provided k is a coefficient in scale factor band s. The value ê[k] [T] can thus be seen as the residual value that would be received from reconstruction using the bits of the bit planes that have been encoded to the current (Tth iteration), i.e. from bp=1 to bp=T.

The distortion for each scale factor band at terminating bit plane T is calculated as

$$d [ s ] [ T ] = 10 * {log}_{10} [ {\sum }_{k = O [ s ]}^{O [ s + 1 ] - 1} {( e [ k ] - \hat{e} [ k ] [ T ] )}^{2} ] ,$$

where 0[s] is the starting frequency element number of scale factor band s. For each scale factor band, the distortion d[s] is compared with its respective mask M[s] in 910.

If, for bp=1 for example, for all the scale factor bands from 0 to B[1], the distortion is below the mask, the encoding for this frame can be stopped and the process continues with the next frame (if any), i.e. the process continues with testing whether there are any more frames in 911. Otherwise, the last scale factor band is recorded which has noise that exceeds the corresponding mask. This scale factor band is, in the example of bp=1, indicated as B[2], which is defined by

d[s][1]≦M[s]∀B[2]<s≦B[1]

(as the minimal value for which this expression is fulfilled).

For bp=1, since in 912 the value of the variable sfb is increased to B[1]+1 and sfb≦B[1] in 914 does therefore not hold, the process continues, by increasing bp by 1 in 915, with 905 such that the coding continues for scale factor bands 0 to B[2] for bp=2 (steps 905 to 908).

For bp=2, the distortion is checked again in 909 after the encoding from 0 to B[2] is done, and if all the encoded scale factor bands have lower energy than the mask (which is checked in 910), the coding will stop for the current frame and proceed to the next frame unless the current frame is the final frame (which is checked in 911). Otherwise, the position of B[3] will be recorded, and the coding will continue in 912, 913 and 914 from B[2]+1 to B[1] for by 2 and followed by 0 to B[3] for bp=3 in 905 to 908.

The coding process continues in this manner until the condition that all the scale factor bands from 0 to B[bp] for bit plane by have lower distortion than the mask is fulfilled.

B[bp] is computed by

d[s][bp−1]≦M[s]∀B[bp]<s≦B[1]

(as the minimal value for which this expression is fulfilled).

The encoding process described above with reference to FIG. 9, referred to as transparent bit plane encoding process in one embodiment, is illustrated in FIG. 10.

FIG. 10 shows a bit plane diagram 1000.

In the bit plane diagram 1000, the bit plane number decreases along a first axis 1001 (y-axis) such that a first bit plane (bp=1) 1003 is at the top.

As an example, a second bit plane 1004 and a third bit plane 1005 are shown in FIG. 10.

The encoding direction within a bit plane 1003, 1004, 1005 is the direction of a second axis 1002 (x-axis) which is in this example also the direction of increasing scale factor band numbers.

In the first bit plane 1001, the bits of the first bit plane 1001 are scanned (e.g. added to a generated bit-stream, which may after generation be, for example, entropy-encoded) according to 906 of FIG. 9 (for bp=1) until a first check point 1006 given by B[1] is reached at which the distortion is checked according to step 909. In one embodiment, this means that it is tested whether the residual values which would arise for the scale factor bands from the bits encoded (scanned) so far differ from the true residual values at most by values as given by the mask, i.e., whether the difference lies beneath a pre-defined masking threshold.

If the mask is exceeded for any scale factor band a second check point 1007 given by B[2] is set and the encoding process continues for the second bit plane 1005 according to 1406 (for bp=2) until a second check point 1007 is reached. At this point, the distortion is checked again according to 1009 and the encoding process either stops (i.e. no further bits are scanned and the generation of the bit stream is for example finished and the bit stream may now, for example, be entropy encoded) or, if the mask is exceeded for any scale factor band, a third check point 1008 is set according to B[3] and the remaining bits of the second bit plane 1004 are encoded according to 913 until B[1] is reached.

Then, the bits of the third bit plane 1005 are encoded until the third check point 1008 is reached and, if the mask is exceeded for any scale factor band, a value B[4] is set and the remaining bits of the third bit plane 1005 are encoded until B[1] is reached. The process continues in this manner until the mask is not exceeded for any scale factor band.

It should be noted that if the encoding does not terminate at a checking point (given by B[bp]) of a bit plane since the mask is exceeded for at least one scale factor bands, the bits of the remaining scale factor bands from s=B[bp]+1 to B[1] in the bit plane (bp) are encoded before the bits of the next bit plane bit plane (bp+1) starts. This is to satisfy the condition that the encoded format can be further enhanced to lossless.

According to the process described above, the encoding stops when the transparent quality can just be obtained. This may be achieved without making any change of a standard decoder (e.g. a standard SLS decoder) necessary.

Let, in one embodiment, be a number of B_{T} bits be the total number of bits available for the scalable audio, i.e. the encoded audio signal, in a period (e.g., from t₁ to t₂), i.e. for a time interval of the audio signal (e.g. if played at the intended speed).

The total bits consumed (e.g. used) in the period from t₁ to t₂ have to fulfill the condition

$${\sum }_{t = {t}_{1}}^{{t}_{2}} {B}_{S} ( q , t ) \leq {B}_{T}$$

where B_{S} (q, t) is the bit amount required for quality level q at time t if the quality level q is to be achieved for every time t in the time interval from t₁ to t₂.

In an embodiment where the encoded audio signal is streamed in real-time, the number of bits necessary for a time interval t₁ to t₂ may be estimated from the bandwidth used in the streaming network for transmitting the encoded audio signal in a previous time interval, e.g. from t₀ to t₁.

This is illustrated in FIGS. 11A and 11B.

FIGS. 11A and 11B show bandwidth-time diagrams 1101, 1102.

In the bandwidth-time diagrams 1101, 1102, time increases in the direction of a time axis (x-axis) 1103 and bandwidth increases in the direction of a bandwidth axis (y-axis) 1104.

A first bandwidth-time diagram 1101 illustrates the bandwidth used for streaming the encoded audio signal in a streaming network for each time t, denoted by B_{N} (t). A first dashed line 1105 illustrates the average of the bandwidth used for the time interval from t₀ to t₁.

A second bandwidth-time diagram 1102 illustrates the bit amount required for quality level q at time t B_{S} (q, t) for three quality levels q₀, q₁, and q₂. A second dashed line 1106 illustrates the average of the bandwidth required for the time interval from t₁ to t₂ at quality level q₁.

The number of bits necessary for encoding the time interval t₁ to t₂ of the audio signal may be estimated from the bandwidth used in the streaming network for transmitting the encoded audio signal in the time interval from t₀ to t₁ for example according to

$${B}_{T} = \frac{1}{( {t}_{1} - {t}_{0} )} {\sum }_{t = {t}_{0}}^{{t}_{1}} {B}_{N} ( t ) .$$

In the following the time interval from t₁ to t₂ is replaced by a frame number interval from i₁ to i₂, e.g. for usage in a real application.

In one embodiment, a required bit rate B_{S}(n,i) is determined for the encoded audio signal for each frame with frame number i with i₁≦i≦i₂ and each quality level n with 1≦n≦S. For example, a quality-level bit rate table B_{S}(n, i), 1≦n≦S, i₁≦i≦i₂ may be constructed.

The determination of the B_{S}(n, i) for 1≦n≦S, i₁≦i≦i₂ is for example carried out according to method illustrated in FIG. 12.

FIG. 12 shows a flow diagram 1200 according to an embodiment.

The flow illustrated in the flow diagram 1200 may be seen to be similar as the flow described with reference to FIG. 9 for the smart enhancer. The main differences may be seen to include:
There is a distortion check at the start of the coding process;
The process may be carried out for a plurality of values of n where 1≦n≦S. There may be as many output bit rates for each frame as different values of n are used.

The process is started in 1201 with the first frame of the input audio signal 501. The input audio signal in the time domain is transferred into spectrum domain by the domain transforming circuit 506 (e.g. by an IntMDCT transform (with or without M/S (Main/Side) coding)) and encoded in 1202 by the lossy encoding circuit 503, e.g. according to the MPEG-4 AAC encoding method. A perceptual hearing mask for this frame, given by a set of energy level values M[s], is generated in the coding process, with 0≦s<S where s is the scale factor band (sfb) number and S is the total number of scale factor bands.

In 1203, as described above with reference to FIG. 5, the error mapping process carried out by the error mapping circuit 504 by calculating the difference between the lossy coded frequency components (e.g. the AAC coded spectrum) and the original spectrum provided by the domain transforming circuit 506.

The residual signal values provided by the error mapping circuit are structured into residual bit planes by the bit stream encoding circuit 505. Let for each scale factor band s the maximum bit plane level (i.e. the position of the most significant bit in the bit words corresponding to the scale factor band s) be given by b_{M}[s]. The residual bit planes are processed according to a bit plane coding process, which may be carried out according to BPGC, CBAC or LEMC (Low Energy Mode Code).

The coding sequence that is used may be seen to correspond, in principle, to bit plane scanning according to SLS as illustrated in FIG. 7. For each scale factor band, the bit plane coding starts from b_{M}[s]. For example, for s=48, b_{M}[s]=5. For the whole frame, the bit plane to be coded (in other words, scanned) is indicated by bp. As shown in FIG. 7, the first bit plane (bp=1) includes the bit planes with scanning order “1”. The second by includes the bit planes with scanning order “2”, and so on.

In 1204, the current (i.e. the currently processed) bit plane to be coded is set to bp=1.

In 1205, a distortion check is performed for the first bit plane (bp=1). This distortion check and the determination of the distortion d[s] is for example carried out as explained with reference to 909 in FIG. 9 above.

In 1206, for each scale factor band s, the distortion d[s] determined in the distortion check in 1205 is compared with its respective mask M[s] and it is checked whether the number of scale factor bands for which the distortion d[s] exceeds the mask M[s] is below the currently selected value n, which may be seen to indicate a quality level n.

If the number of scale factor bands for which the distortion d[s] exceeds the mask M[s] is below n, the number of bits used for encoding the current frame so far (i.e. required for the encoded audio signal for which the distortion check in 1205 has been carried out) are recorded as Bₛ(n, i) for the currently selected value n and the current frame i. The process then continues with 1219.

If the number the number of scale factor bands for which the distortion d[s] exceeds the mask M[s] is not below n, the process continues with 1208.

For bp=1, the bit plane coding starts from sfb=0 in 1208 which is increased by 1 in 1210 after bit plane coding the current (currently processed) scale factor band sfb of the current bit plane in 1209. In 1211, it is checked whether sfb<B[bp]+1.

If this is the case the process returns to 1209 (with increased sfb) such that the scale factor runs (in the loop formed by 1209 and 1211) from sfb=0 to sfb=B[bp].

B[1] is for example defined as described above with reference to 908 in FIG. 9.

If sfb<B[bp]+1 does not hold, the process continues with 1212. In 1212, a distortion check is performed for the current bit plane bp. This distortion check is for example carried out as explained with reference to 909 in FIG. 9 above.

In 1213, for each scale factor band s, the distortion d[s] determined in the distortion check in 1212 is compared with its respective mask M[s] and it is checked whether the number of scale factor bands for which the distortion d[s] exceeds the mask M[s] is below the currently selected value n, which may be seen to indicate a quality level n.

If the number the number of scale factor bands for which the distortion d[s] exceeds the mask M[s] is below n, the number of bits used for encoding the current frame so far (i.e. required for the encoded audio signal for which the distortion check in 1205 has been carried out) are recorded as B_{S}(n, i) for the currently selected value n and the current frame i in 1214. The process then continues with 1219 in which it is checked whether the last frame i₂ has been reached. If the last frame has been reached, the processing is ended. Otherwise, the frame number i is increased by 1 and the process continues (for the next frame) with 1202.

Otherwise, the last scale factor band is recorded which has noise that exceeds the corresponding mask. This scale factor band is, in the example of bp=1, indicated as B[2], which is defined by

d[s][1]≦M[s]∀B[2]<s≦B[1]

(as the minimal value for which this expression is fulfilled) and analogously for higher by than 1, i.e.

d[s][bp]≦M[s]∀B[bp+1]<s≦B[bp].

The process then continues with 1215. In 1215 the value of the variable sfb is increased by 1 and in 1217 it is checked whether sfb is below S. If sfb is below S, the bit of the scale factor band is included in the output bit-stream of the bit-plane coding in 1216. 1215 to 1217 thus form a loop such that the coding continues for scale factor bands 0 to S which is left, when sfb is not below S and the process continues in 1218.

In 1218, the value by is increased by 1 and the processing continues with 1208 (for the next bit-plane).

The coding process continues in this manner until B_{S}(n, i) has been determined for all i₁ from it to i₂.

The process described above with reference to FIG. 12 is further illustrated in FIG. 13.

FIG. 13 shows a bit plane diagram 1300.

In the bit plane diagram 1300, the bit plane number decreases along a first axis 1301 (y-axis) such that a first bit plane (bp=1) 1303 is at the top.

As an example, a second bit plane 1304 and a third bit plane 1305 are shown in FIG. 13.

The encoding direction within a bit plane 1303, 1304, 1305 is the direction of a second axis 1302 (x-axis) which is in this example also the direction of increasing scale factor band numbers.

Before the first bit plane 1301 is scanned, it is checked whether the determined residual values in the error mapping in 1203 are higher than the mask, i.e., whether the residual values lie above a pre-defined masking threshold, for less than n scale factor bands. This may be seen as a first distortion check at the start of the bit-plane coding process at a first check point 1306.

If the determined residual values are higher than the mask for n or more scale factor bands, the bits of the first bit plane 1301 are scanned according to 1209 of FIG. 12 (for by

=1) until a second check point 1307 given by B[1] is reached at which the distortion is checked according to step 1212. In one embodiment, this means that it is tested whether the residual values which would arise for the scale factor bands from the bits encoded (scanned) so far differ from the true residual values at most by values as given by the mask, i.e., whether the difference lies beneath a pre-defined masking threshold, for less than n scale factor bands.

If the mask is exceeded for n or more scale factor bands a third check point 1308 given by B[2] is set and the encoding process continues for the second bit plane 1305 according to 1209 (for bp=2) until the third check point 1308 is reached. At this point, the distortion is checked again according to 1212 and the encoding process either stops (i.e. no further bits are scanned and the generation of the bit stream is for example finished and the bit stream may now, for example, be entropy encoded) or, if the mask is exceeded for n or more scale factor bands, a fourth check point 1309 is set according to B[3] and the remaining bits of the second bit plane 1304 are encoded according to 1216 until B[1] is reached.

Then, the bits of the third bit plane 1305 are encoded until the fourth check point 1309 is reached and, if the mask is exceeded for n or more scale factor bands, a value B[4] is set and the remaining bits of the third bit plane 1305 are encoded until B[1] is reached. The process continues in this manner until the mask is not exceeded for n or more scale factor bands.

The values B_{S}(n, i) determined for the frames i=i₁, . . . , i₂ and the quality levels n, with 1≦n≦S may be used for frame truncation, i.e. used to determine how many bits of the full bit-stream generated from the complete bit-plane scanning process are actually used for a frame.

Given that the total bits available for frames from i₁ to i₂ are B_{T} bits, the assigned bits B(i) for a particular frame i, i₁≦i≦i₂, can be computed as

$$B ( i ) = {B}_{S} ( k + 1 , i ) + \frac{1}{2} [ B - {\sum }_{i = {i}_{1}}^{{i}_{2}} {B}_{S} ( k , i ) ] [ \frac{{B}_{S} ( k , i )}{{\sum }_{i = {i}_{1}}^{{i}_{2}} {B}_{S} ( k , i )} + \frac{{B}_{S} ( k + 1 , i )}{{\sum }_{i = {i}_{1}}^{{i}_{2}} {B}_{S} ( k + 1 , i )} ]$$

$$if {\sum }_{i = {i}_{1}}^{{i}_{2}} {B}_{S} ( k + 1 , i ) < {B}_{T} < {\sum }_{i = {i}_{1}}^{{i}_{2}} {B}_{S} ( k , i ) and B ( i ) = {B}_{s} ( k , i )$$

$$if {\sum }_{i = {i}_{1}}^{{i}_{2}} {B}_{s} ( k , i ) = {B}_{T} .$$

Alternatively, the assigned bits B(i) for a particular frame i, i₁≦i≦i₂, may also be computed as

$$B ( i ) = {B}_{S} ( k , i ) + [ B - {\sum }_{i = {i}_{1}}^{{i}_{2}} {B}_{S} ( k , i ) ] [ \frac{{B}_{S} ( k , i )}{{\sum }_{i = {i}_{1}}^{{i}_{2}} {B}_{S} ( k , i )} ]$$

$$if {\sum }_{i = {i}_{1}}^{{i}_{2}} {B}_{S} ( k + 1 , i ) < {B}_{T} < {\sum }_{i = {i}_{1}}^{{i}_{2}} {B}_{S} ( k , i )$$

$$and B ( i ) = {B}_{s} ( k , i )$$

$$if {\sum }_{i = {i}_{1}}^{{i}_{2}} {B}_{s} ( k , i ) = {B}_{T} .$$

As a further alternative, the assigned bits B(i) for a particular frame i, i₁≦i≦i₂, may also be computed as

$$B ( i ) = {B}_{S} ( k , i ) + [ B - {\sum }_{i = {i}_{1}}^{{i}_{2}} {B}_{S} ( k , i ) ] [ \frac{{B}_{S} ( k + 1 , i )}{{\sum }_{i = {i}_{1}}^{{i}_{2}} {B}_{S} ( k + 1 , i )} ]$$

$$if {\sum }_{i = {i}_{1}}^{{i}_{2}} {B}_{S} ( k + 1 , i ) < {B}_{T} < {\sum }_{i = {i}_{1}}^{{i}_{2}} {B}_{S} ( k , i )$$

$$and B ( i ) = {B}_{s} ( k , i )$$

$$if {\sum }_{i = {i}_{1}}^{{i}_{2}} {B}_{s} ( k , i ) = {B}_{T} .$$

According to the formulas given above for determining variable-bit rate truncation B(i) to have a certain quality level n (or k as in the formulas above) for a particular frame i, variable-bit rate truncation may be used, i.e. the resulting bit-stream for each frame may be truncated to a length corresponding to B(i) for that frame individually for the frame. This is for example done such that for each frame, the portion of the bit-plane scanning bit stream corresponding to the B_{S}(k, i) to be used for the frame is used. The values of n may for example include 1, 4, 7, 10, 13, 21 and 40.

In one embodiment, negative values may be used for n. While a positive value of n specifies a quality level in which the mask is exceeded by the distortion for less than n scale factor bands as described above, a negative n may be used to specify a quality level in which the distortion is lower than the mask (e.g. by a predetermined difference level) for −n (i.e. the absolute value of n) scale factor bands.

For example, if n=−1, B_{S}(−1,i) is determined such that there is one sfb in frame i for which the distortion is lower than the mask by a predetermined difference level, e.g. 5 dB. When n=−5, B_{S}(−5,i) is determined such that there are 5 sfbs in frame i for which the distortion is lower than the mask by the predetermined difference level.

Accordingly, for a negative n, it is checked in 1206 and 1213 whether the number of scale factor bands for which the distortion d[s] is below the mask M[s] by the predetermined difference level is above the absolute value of n. The process continues depending on the result of the check analogously to the case of a positive n as described above.

Simulations show that with the same bit rate (e.g. 142 kbps) transparent quality can be achieved by using variable quality truncation while the result of using constant bit rate truncation is far from transparent.

The following documents are cited in the specification:
[1] Scalable Lossless Coding (SLS), ISO/IEC 14496-3:2005/Amd 3, 2006.
[2] R. Yu, S. Rahardja, X. Lin, and C. C. Koh, “A fine granular scalable to lossless audio coder,” IEEE Trans. Audio, Speech, Lang. Process., vol. 14, no. 4, pp. 1352-1363, July 2006.

1. A method for determining a number of bits for encoding an audio signal comprising a core audio signal portion and a residual audio signal portion, the method comprising selecting, from the residual audio signal portion, a reference residual audio signal portion and at least one candidate residual audio signal portion;
comparing the reference residual audio signal portion with the candidate residual audio signal portion; and
determining the number of bits for encoding the audio signal depending on the result of the comparison.

2. The method according to claim 1, further comprising encoding the audio signal using the determined number of bits.

3. The method according to claim 1 or 2, wherein the audio signal is a frame of an audio signal comprising a plurality of frames.

4. The method according to any one of claims 1 to 3, further comprising determining, based on the result of the comparison, whether or not the at least one candidate residual audio signal portion fulfills a pre-determined quality criterion.

5. The method according to any one of claims 1 to 4, wherein the number of bits is determined as the number of bits of the candidate residual audio signal portion if the candidate residual audio signal portion fulfills the pre-determined quality criterion.

6. The method according to any one of claims 1 to 5, further comprising selecting at least one other candidate residual audio signal portion from the residual audio signal portion;
determining, from among the candidate residual audio signal and the at least one other candidate residual audio signal portion, a first residual audio signal portion for which the pre-determined quality criterion is fulfilled by at least a comparison of the candidate residual audio signal portion with the reference residual candidate audio signal portion;
determining, from among the candidate residual audio signal and the at least one other candidate residual audio signal portion, a second residual audio signal portion for which a pre-determined other quality criterion is fulfilled by at least a comparison of the candidate residual audio signal portion with the reference residual candidate audio signal portion; and
determining the number of bits for encoding the frame based on the first candidate residual audio signal portion and the second candidate residual audio signal portion.

7. The method according to any one of claims 1 to 6, wherein the core audio signal portion comprises a plurality of core audio signal values and wherein the residual audio signal portion comprises a plurality of residual audio signal values.

8. The method according to any one of claims 1 to 7, wherein the reference residual audio signal portion is the residual audio signal portion.

9. The method according to any one of claims 1 to 8, wherein the reference candidate residual audio signal portion is different from the candidate residual audio signal portion.

10. The method according to any one of claims 1 to 9, wherein comparing the reference candidate residual audio signal portion with the candidate residual audio signal portion comprises checking whether the difference between at least one first residual value reconstructed from the reference candidate residual audio signal portion according to a pre-determined reconstruction scheme and at least one second residual value reconstructed from the candidate residual audio signal portion according to the pre-determined reconstruction scheme is lower than a pre-defined threshold.

11. The method according to claim 10, wherein the pre-defined threshold is based on a human hearing perception threshold.

12. The method according to claim 10, wherein the pre-defined threshold is based on a human hearing mask.

13. The method according to any one of claims 10 to 12, wherein the residual audio signal portion includes a plurality of residual audio signal values and the number of bits for encoding the audio signal is determined depending on the number of residual values, for which the difference between a first corresponding residual value reconstructed from the reference candidate residual audio signal portion according to a pre-determined reconstruction scheme and a second corresponding residual value reconstructed from the candidate residual audio signal portion according to the pre-determined reconstruction scheme is lower than the pre-defined threshold.

14. The method according to any one of claims 1 to 13, wherein the residual audio signal portion comprises a plurality of residual audio signal values, and wherein selecting the second candidate residual audio signal portion is performed based on a bit word representation of each residual audio signal value and based on an order of the residual audio signal values.

15. The method according to claim 14, wherein selecting the candidate residual audio signal portion comprises determining a minimum bit significance level;
determining a border signal value position;
including all bits of the bit word representations of the residual audio signal values that have, in their respective bit word, a higher bit significance level than the minimum bit significance level; and
including all bits of the bit word representations of the residual audio signal values that have, in their respective bit word, the minimum bit significance level and that are part of a bit word representation of a signal value that has a position which fulfills a pre-defined condition with regard to the border signal value position.

16. The method according to claim 15, wherein the pre-defined condition is one of
the position being below the border signal value position;
the position being below or equal to the border signal value position;
the position being above the border signal value position; and
the position being above or equal to the border signal value position.

17. The method according to claim 15 or 16, wherein the minimum bit significance level is determined based on a comparison of the reference candidate residual audio signal portion with a further candidate residual audio signal portion or is a pre-defined minimum bit significance level.

18. The method according to any one of claims 15 to 17, wherein the border signal value position is determined based on a comparison of the first candidate residual audio signal portion with a further candidate residual audio signal portion or is a pre-defined border signal value position.

19. The method according to any one of claims 15 to 18, wherein each residual audio signal value corresponds to at least one frequency.

20. The method according to claim 19, wherein each residual audio signal value corresponds to at least one scale factor band.

21. A device for determining a number of bits for encoding an audio signal comprising a core audio signal portion and a residual audio signal portion, comprising:
a selecting circuit configured to select, from the residual audio signal portion, a reference residual audio signal portion and at least one candidate residual audio signal portion;
a comparing circuit configured to compare the reference residual audio signal portion with the candidate residual audio signal portion; and
a determining circuit configured to determine the number of bits for encoding the audio signal depending on the result of the comparison.

22. A computer program product, which, when executed by a computer, makes a computer perform a method for determining a number of bits for encoding an audio signal comprising a core audio signal portion and a residual audio signal portion, the method comprising
selecting, from the residual audio signal portion, a reference residual audio signal portion and at least one candidate residual audio signal portion;
comparing the reference residual audio signal portion with the candidate residual audio signal portion; and
determining the number of bits for encoding the audio signal depending on the result of the comparison.
